(19) United States
(12) Patent Application Publication
(10) Pub. No.: US 2014/0357546 A1
(43) Pub. Date: Dec. 4, 2014

(54) TRANSPARENT AQUEOUS FRAGRANCE MICROEMULSIONS

(71) Applicant: Dow Global Technologies LLC, Midland, MI (US)

(72) Inventors: Christian Piechocki, II, Marienthal (FR); Michael L. Tulchinsky, Midland, MI (US)

(21) Appl. No.: 14/365,891

(22) PCT Filed: Dec. 11, 2012
(86) PCT No.: PCT/US2012/068899

§ 371 Date: Jun. 16, 2014

Related U.S. Application Data
(60) Provisional application No. 61/579,040, filed on Dec. 22, 2011.

(51) Int. Cl. C11B 9/00

(52) U.S. Cl. CPC C11B 9/00
USPC 512/3

(57) ABSTRACT

Described are methods for making transparent aqueous microemulsions, as well as compositions and uses for the same.

### CROSS-REFERENCE TO RELATED APPLICATIONS

This application claims priority to and is a 371 U.S.C. §371 national phase application of International Application No. PCT/US12/068899, filed on Dec. 11, 2012, which claims priority from provisional application Ser. No. 61/579,040, filed Dec. 22, 2011, which are incorporated herein by reference in its entireties.

### FIELD

The present invention relates to methods for making transparent aqueous microemulsions, as well as compositions and uses for the same.

### BACKGROUND

The need for transparent aqueous fragrance microemulsions is longstanding. An award-winning microemulsion is described in WO/2005/123028. In that publication, an ethanol-free aqueous cosmetic composition is described that is based upon efficient, optically clear, non-greasy, non-tacky fragrance microemulsions. The cosolvents, 1,2-hexanediol and 1,2 heptanediol, are shown to have unique properties that allow low surfactant formulations with high active loading. However, there is a need for identifying other cosolvents, and expanding the adoption of microemulsion technology in personal care.

### DETAILED DESCRIPTION

In one embodiment, the present invention provides a personal care composition, comprising a microemulsion including a compound of Formula I:

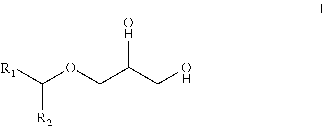

wherein:
R₁ is H or methyl;
R₂ is substituted or unsubstituted C₃-C₅ alkyl, or CH₂(OH)—CH₂—O—R₃;

wherein R₃ is C₆-C₈ alkyl.

In one embodiment, R₂ is n-propyl, isopropyl, n-butyl, isobutyl, or sec-butyl.

In one embodiment, R₂ is CH₂(OH)—CH₂—O—R₃, and R₃ is heptyl or octyl.

Compounds of the Formula I may be synthesized by catalytic reductive etherification in a known manner.

The amount of the compound of Formula I present in the microemulsion is generally from 1% by weight to 50 wt. %, preferably from 1 wt. % to 25 wt. %, more preferably from 3 wt. % to 20 wt. %, and most preferably from 5 wt. % to 15 wt. %.

A “microemulsion” as the term is used herein denotes a pseudo one-phase transparent mixture of two immiscible fluids. Microemulsions are thermodynamically stable and form spontaneously. Microemulsions are transparent or translucent, and do not display the opalescence of standard emulsions. The particle size of the resulting droplets is small enough so the resulting mixture is optically clear or translucent. Microemulsion droplet sizes are variously defined in the art with a droplet size typically below 0.14 micron.

In one embodiment, the microemulsion further comprises an aqueous medium, preferably water. The amount of aqueous medium present in the composition is generally from 50 wt. % to 95 wt. %, preferably from 55 wt. % to 90 wt. % and more preferably from 60 wt. % to 85 wt. %.

In one embodiment, the microemulsion further comprises one or more surfactants. Cationic, anionic, non-ionic, zwitterionic, amphophilic, or polymeric surfactants, and mixtures thereof may be used. Preferred surfactants include mixtures of non-ionic surfactants and anionic surfactants, mixtures of non-ionic surfactants and cationic surfactants, and mixtures of non-ionic surfactants and zwitterionic surfactants. Examples of particularly preferred surfactants are ethyloxalated alkanes, fatty acids, fatty acid salts, sulfonates or quaternary ammonium salts, and especially polyoxyethylene fatty ether surfactants, stearic acid and stearic acid salts, most preferably the sodium salt of stearic acid, sodium lauryl sulfate (SLS), sodium laureth sulfate (SLES), lauryl trimethyl ammonium chloride, Brij 30 (trademark of Uniqema, Chemical Abstracts name Poly(oxy-1,2-ethanediyl), alpha-dodecyl-omega-hydroxy-(9CI), Registery Number 9002-92-0), cetyl trimethyl ammonium chloride, or combinations thereof. In one embodiment, the surfactants are a mixture of non-ionic surfactants and anionic surfactants in a ratio of from 65:35 to 35:65, preferably 60:40.

The amount of surfactant which may be used in the composition of the present invention is generally from 0 wt. % to 50 wt. %, preferably from 0 wt. % to 20 wt. %, more preferably from 0 to 15 wt. % and most preferably from 0 to 10 wt. %; and when the surfactant is present in the composition, the amount of surfactant is preferably from 0.1 wt. % to 15 wt. %, and more preferably from 0.5 wt. % to 10 wt. %.

In one embodiment, the microemulsion further comprises contain one or more additional ingredients, such as antioxidants, chelating agents, UV filters, preservatives, thickening agents, cosmetic active ingredients, moisturizers, humectants, emollients, opacifiers, pearly gloss impacting substances, pigments, colorants, dyes and antifoams. The additional ingredients are generally present in the composition of the present invention from 0 wt % to 5 wt %, preferably from 0.5 wt % to 3 wt %, and more preferably from 0.1 wt % to 1 wt %.

The microemulsion perfumed aqueous cosmetic composition according to the present invention may be prepared, for example, by simple mixing of all the ingredients; for example by hand stirring or if need be by using a mechanical mixer (i.e. by some mechanically agitating means), the components of the present invention, and any optional components, to form a homogeneous mixture. The components of the present invention may be added together into a suitable reaction vessel and mixed in any order, using conventional processes well known to those skilled in the art. The microemulsion may be produced at room temperature or at an elevated temperature, for example up to 90° C., preferably up to 55° C. can be employed. Microemulsions can be formulated to be optically clear, and stable from 5° C. to 55° C.

In one embodiment, the microemulsion further comprises a fragrance, such as natural and/or synthetic fragrance raw materials, such as essential oils. Of particular interest are oil soluble perfume oils. Microemulsion compositions of the present invention exhibit low odor, pleasant skin feel, and can be formulated as clear stable perfumes with high fragrance loading, for example, from 1 percent by weight to 30 percent by weight essential oils in several different product forms, such as fragrances, Eaux de Toilettes, aqueous perfumes, body sprays, body deodorants as well as products such as refreshing and cleaning wet towels, aqueous cosmetic compositions, household cleaners, air fresheners and sprayable formulations. The perfumed aqueous microemulsion composition will advantageously include from 1% by weight (wt. %) to 50 wt. %, preferably from 1% by weight (wt. %) to 30 wt. %, and most preferably 2 wt. % to 30 wt. % of such fragrance materials. The weight ratio between the fragrance material and the surfactant, if present in the composition of the present invention, generally is from 0.2:1 to 10:1, preferably from 0.5:1 to 6:1, more preferably from 1:1 to 5:1, and most preferably from 2:1 to 4:1.

In one embodiment, the perfume is ethanol-free. “Ethanol-free” means substantially free of ethanol, i.e., less than 1 wt %, and more preferably zero weight percent.

### EXAMPLES

### Example 1

Fragrance microemulsions of the present invention are described in TABLE 1A & 1B in grams:

TABLE 1A

| | Batch A | Batch B | Batch C | Batch D |
|---|---|---|---|---|
| BRIJ 97 nonionic | 0.27 | 0.27 | 0.27 | 0.27 |
| surfactant | | | | |
| AOT 75 anionic | 0.24 | 0.24 | 0.24 | 0.24 |
| surfactant | | | | |
| Fragrance Oil | 0.75 | 0.75 | 0.75 | 0.75 |
| Water | 2.99 | 2.99 | 2.99 | 2.99 |
| 3-(penthyloxy)-1,2- | q.s. trans- | — | — | — |
| propanediol | parent | | | |
| 3-(3-methylbutoxy)-1,2- | — | q.s. trans- | — | — |
| propanediol | | parent | | |
| 3-(2-methylbutoxy)-1,2- | — | — | q.s. trans- | — |
| propanediol | | | parent | |
| 3-(1-methylbutoxy)-1,2- | — | — | — | q.s. trans- |
| propanediol | | | | parent |

TABLE 1B

| | Batch E | Batch F | Batch G |
|---|---|---|---|
| BRIJ 97 nonionic | 0.27 | 0.27 | 0.27 |
| surfactant | | | |
| AOT 75 anionic | 0.24 | 0.24 | 0.24 |
| surfactant | | | |
| Fragrance Oil | 0.75 | 0.75 | 0.75 |
| Water | 2.99 | 2.99 | 2.99 |
| 3-[2-hydroxy-3-(heptyloxy) | q.s. trans- | — | — |
| propoxy]-1,2-propanediol | parent | | |
| 3-[2-hydroxy-3-(2- | — | q.s. trans- | — |
| ethylhexyloxy) propoxy]-1,2- | | parent | |
| propanediol | | | |
| 3-(butoxy)-1,2-propanediol | — | — | q.s. trans- |
| | | | parent |

The components are mixed until a transparent microemulsion forms, usually requiring on average 0.75g of a compound of Formula I. The Fragrance Oil:Surfactant ratio is 1.667, and the ratio of nonionic to anionic surfactant is 60:40.

### Example 2

### Comparative

A fragrance microemulsion of the prior art is described in TABLE 2 in grams:

TABLE 2

| | Comparative Batch 1 |
|---|---|
| BRIJ 97 nonionic surfactant | 0.27 |
| AOT 75 anionic surfactant | 0.24 |
| Fragrance Oil | 0.75 |
| Water | 2.99 |
| 1,2 Hexane Diol | q.s. transparent ~0.75g |

The components are mixed until a transparent microemulsion forms.

### Example 3

Compositions substantially according to Examples 1 and 2 were made and compared for solvent efficiency, the amount of specified compound of Formula I required to make a transparent microemulsion in comparison to the amount of 1,2 Hexane Diol required to make Comparative Batch 1. Batches A-C were repeatedly found to more efficient (requiring less respective compound of Formula I (for Batch A: 0.68-0.8 depending on fragrance; for Batch B: 0.69-0.89 depending on fragrance; for Batch C: 0.69-0.7 depending on fragrance)) than the comparative batch. Batch E was almost comparable to Comparative Batch 1. Batches D, F, and G were not as efficient, Batch F yielding only gels.

### Example 4

Fragrance microemulsions of the present invention are described in TABLE 3A & 3B in grams:

TABLE 3A

| | Batch A′ | Batch B′ | Batch C′ | Batch D′ |
|---|---|---|---|---|
| Cremophor RH 40 | 0.11 | 0.11 | 0.11 | 0.11 |
| nonionic surfactant | | | | |
| AOT 75 anionic | 0.10 | 0.10 | 0.10 | 0.10 |
| surfactant | | | | |
| Fragrance Oil | 0.75 | 0.75 | 0.75 | 0.75 |
| Water | 3.29 | 3.29 | 3.29 | 3.29 |
| 3-(penthyloxy)-1,2- | q.s. trans- | — | — | — |
| propanediol | parent | | | |
| 3-(3-methylbutoxy)-1,2- | — | q.s. trans- | — | — |
| propanediol | | parent | | |
| 3-(2-methylbutoxy)-1,2- | — | — | q.s. trans- | — |
| propanediol | | | parent | |
| 3-(1-methylbutoxy)-1,2- | — | — | — | q.s. trans- |
| propanediol | | | | parent |

TABLE 3B

| | Batch E′ | Batch F′ | Batch G′ |
|---|---|---|---|
| Cremophor RH 40 | 0.11 | 0.11 | 0.11 |
| AOT 75 anionic | 0.10 | 0.10 | 0.10 |
| surfactant | | | |
| Fragrance Oil | 0.75 | 0.75 | 0.75 |
| Water | 3.29 | 3.29 | 3.29 |
| 3-[2-hydroxy-3-(heptyloxy) | q.s. trans- | — | — |
| propoxy]-1,2-propanediol | parent | | |
| 3-[2-hydroxy-3-(2- | — | q.s. trans- | — |
| ethylhexyloxy) propoxy]-1,2- | | parent | |
| propanediol | | | |
| 3-(butoxy)-1,2-propanediol | — | — | q.s. trans- |
| | | | parent |

The components are mixed until a transparent microemulsion forms, usually requiring on average 0.75 g of a compound of Formula I. The Fragrance Oil:Surfactant ratio is 4.0, and the ratio of nonionic to anionic surfactant is 60:40.

### Example 5

Compositions substantially according to Examples 4 and 2 were made and compared for solvent efficiency, the amount of specified compound of Formula I required to make a transparent microemulsion in comparison to the amount of 1,2 Hexane Diol required to make Comparative Batch 1. Batches A′-C′ and E′ were found to more efficient (requiring less respective compound of Formula I (for Batch A′: 0.62-0.72 depending on fragrance; for Batch B′: 0.85 (one fragrance); for Batch C′: 0.77 (one fragrance)) than the comparative batch. Batch E′ was better than Comparative Batch 1. Batches D′ and G′ were unacceptable. A blend of Batch A′ and Batch F′ was more efficient than Comparative Batch 1.

1. A personal care composition, comprising:
a microemulsion including a fragrance material and a compound of Formula I: 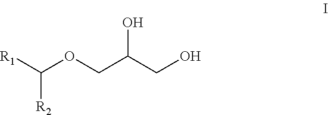
wherein:
R₁ is H or methyl;
R₂ is substituted or unsubstituted C₃-C₅ alkyl, or CH₂(OH)—CH₂—O—R₃;
wherein R₃ is C₆-C₈ alkyl.

2. The personal care composition of claim 1, wherein R₂ is n-propyl, isopropyl, n-butyl, isobutyl, or sec-butyl.

3. The personal care composition of claim 1, wherein R₂ is CH₂(OH)—CH₂—O—R₃, and R₃ is heptyl or octyl.

4. The personal care composition of claim 1, wherein R₁ is H and R₂ is n-butyl, isobutyl, or sec-butyl.

5. The personal care composition of claim 1, further comprising water.

6. The personal care composition of claim 1, further comprising a nonionic surfactant.

7. The personal care composition of claim 1, further comprising an anionic surfactant.

8. The personal care composition of claim 1, further comprising a nonionic surfactant and an anionic surfactant.

9. The personal care composition of claim 1, wherein the fragrance material is a blend of essential oils.
